(19) United States
(12) Patent Application Publication
(10) Pub. No.: US 2025/0014538 A1
(43) Pub. Date: Jan. 9, 2025

(54) GUITAR AND CORRESPONDING TRAVEL SET

(71) Applicants: Louis MOREL, NANTES (FR); Antonin GIRARDEAU, MENNECY (FR)

(72) Inventors: Louis MOREL, NANTES (FR); Antonin GIRARDEAU, MENNECY (FR)

(21) Appl. No.: 18/573,805

(22) PCT Filed: Jun. 21, 2022
(86) PCT No.: PCT/EP2022/066854

§ 371 Date: Jul. 29, 2024

(30) Foreign Application Priority Data
Jun. 23, 2021 (FR) 2106668

(51) Int. Cl. G10D 1/08; G10D 3/095; G10G 7/00

(52) U.S. Cl. CPC G10D 1/08; G10D 3/095; G10G 7/005

(57) ABSTRACT

The invention relates to a travelling guitar comprising, on the one hand, a body (1) delimited by a soundboard (2), sides or body sides (3) and a bottom deck (4) and, on the other hand, a neck (10) and a headstock and strings, which are detachable from the body, the bottom deck (4) also being detachable from the body in order to gain access to the interior volume thereof, characterized in that the means for assembling the bottom deck (4) with the body (1) consist of a peripheral rim (4a) of the bottom deck (4) to form a peripheral binding tightly encompassing the free edge (3a) of the body sides (3). It also relates to a travel set using the volume of the body as a compartment in which to stow personal effects of the user.

### TECHNICAL FIELD

There are many documents that describe portable musical instruments, such as those with a soundboard covering a resonating body and a set of strings stretched over this soundboard and a neck, which on the one hand, may be disassembled, for example, with a detachable neck to reduce the bulkiness when it is being transported.

An example of such documents is U.S. Pat. No. 6,025,548 that describes a disassemblable guitar with a body made of two half-bodies that may be assembled or detached so as to provide access to its interior volume to house, in a part of it, the neck, headstock and strings of the instrument. This architecture aims to make the instrument more compact while providing protection to the most fragile parts.

Another example is document U.S. Pat. No. 7,705,224 that reveals a guitar from which a trapezoidal part of the soundboard is disassembled along with the neck, headstock and strings, which leaves an open body that may be closed up by means of an auxiliary panel that takes the place of this removed part to make a suitcase for personal effects. According to this document, the reconstruction of the guitar to regain a sound quality equivalent to that of a non-disassemblable guitar requires a particular arrangement consisting of using the strings and their tension for securing the trapezoidal part to the rest of the soundboard, which requires that a sufficiently important part of this soundboard be kept to withstand this tension. In addition, it is necessary to provide another item of luggage to contain the soundboard portion, the neck and the headstock that have been previously separated from the guitar.

This document thus presents a solution to the problem posed by the bulkiness of any guitar for any guitarist when travelling, especially by aeroplane. In fact, by disassembling the soundboard, the interior volume of the body may be accessed and used to house personal effects other than the “detached parts” of the guitar. However, it does not propose an optimal solution to provide only one piece of luggage to the guitarist.

The present invention provides an alternative solution to this problem by proposing a travel set in which the guitar is a part of this set, the structure of which is adapted to make its interior volume very easily accessible for the purpose of accommodating the personal effects of the traveller and to reconstitute the instrument so that it can be played.

### DISCLOSURE OF THE INVENTION

For this purpose, the principal aim of the invention is to provide a travel guitar comprising, on the one hand, a body delimited by a soundboard, sides or body sides and a bottom deck and, on the other hand, a neck and a headstock and strings, which are detachable from the body, the bottom deck being also detachable from the body to gain access to the interior volume thereof, characterized in that the means for assembling the bottom deck with the body consist of a peripheral rim of the bottom deck to form a peripheral binding tightly encompassing the free edge of the body sides.

This assembly allows the guitar to be disassembled very simply to access the interior volume of the body, and allows it to be reassembled for use as an instrument, which does not require using any tools or means to secure the bottom deck to the body. In addition, it makes it possible to contain any deformation(s) that the body is subjected to during string placement and tension.

Preferably the parts of the body sides and of the bottom deck that co-operate do it by means of an externally flush socket.

In the spirit of the invention, giving precedence to the assembly of the instrument and its disassembly without the use of tools, the soundboard is provided and securely fixed to a bridge comprising its nut and to which is attached, in a releasable manner, a tailpiece to which the strings are permanently attached.

It is therefore possible to assemble the tailpiece to the bridge and therefore to attach the neck to the guitar while the bottom deck is not yet fitted to the body sides. This operation poses the risk of causing a deformation of the soundboard and the body sides, both of which must withstand the stresses of string tension.

To prevent and prohibit this premature assembly of the neck to the body, the invention also relates to a device for clamping the neck to the body that may be used only when the bottom deck is fitted to the body.

For this purpose, in a known manner, the body comprises a housing for receiving the end of the neck limited by a base surface on which an above-mentioned clamping device secures the neck. According to a characteristic of the invention, the clamping device comprises a clamping flange for clamping the neck to the body, movably mounted between an inactive position resting on the base surface of the housing, achieved by the action of a return spring, and an active position, distant from this surface and achieved by a pusher secured to the base, countering the action of the spring and when the latter (4) is assembled to the body.

More precisely, the flange is formed by a rod of which one free end carries the clamping head and the other end is hinged to a support, sliding into a sleeve fitted in the body sides of the body and subjected to the action of the above-mentioned spring and the opposing action of the pusher.

In addition, the aforementioned rod co-operates laterally with a transverse pusher to tilt it around its hinge, to move the clamping head in an escapement orientation, against the action of another return spring that tends to keep it in its clamping orientation.

Finally, the aforementioned pusher is formed by the end of a captive bolt in the bottom deck of the body and comprising on the exterior of the latter a maneuvering wing nut for it to be screwed/unscrewed within the support of the clamping rod for tightening/loosening the flange against the neck.

A second object of the invention consists of a travel set comprising the guitar described above and a container thereof such as a bag, suitcase or cover having a front and rear wall, each forming an access panel within the interior of the container.

Preferably, this set comprises a trim that may be fitted to the bottomless body. The side of the trim facing the soundboard comprises wedging embossings at least for the neck of the guitar.

Other characteristics and advantages of the invention appear from the following description of an embodiment.

### BRIEF DESCRIPTION OF THE DESIGNS

The invention may be better understood from the following description and drawings. Reference is made to the figures, in which:

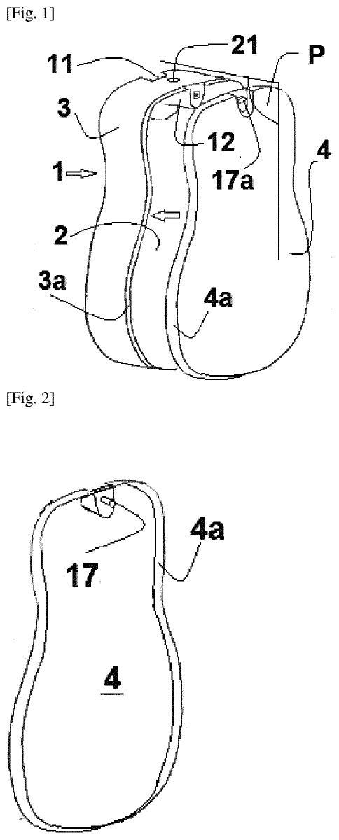

FIG. 1 is a view of a guitar body according to the invention with the bottom deck set apart ready to be fitted to the case.

FIG. 2 is a view of the concave face of the bottom deck.

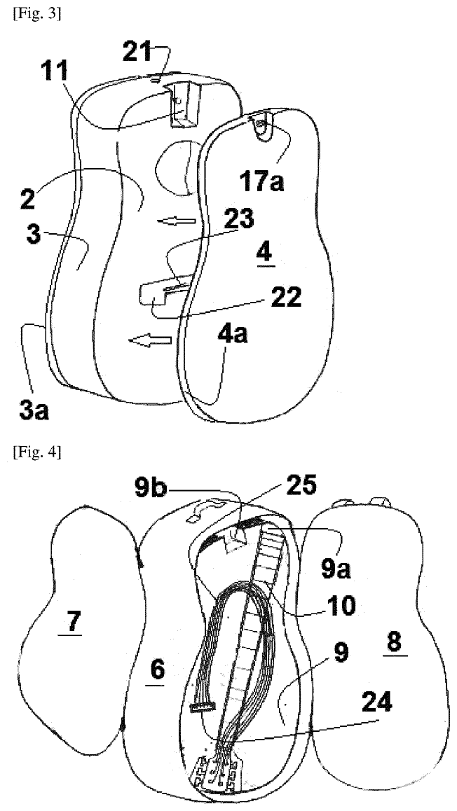

FIG. 3 shows how the bottom deck is able to fit the soundboard of the guitar body.

FIG. 4 shows a backpack-shaped cover and its trim.

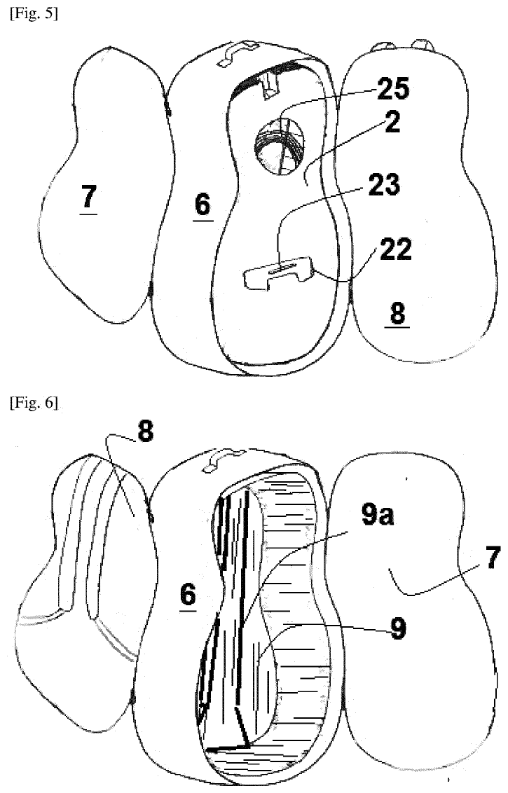

FIG. 5 shows the convex face of the trim with its stowage compartments.

FIG. 6 shows the travel set according to the invention comprising the parts shown in FIGS. 4 and 5 and the guitar case covering the trim.

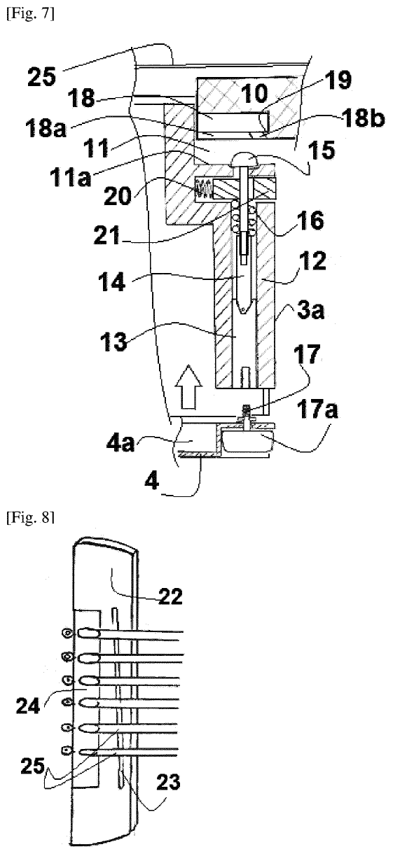

FIG. 7 is a cross-sectional detailed view according to the plane P of [FIG. 1].

FIG. 8 is a diagram of a bridge and its tailpiece.

### DETAILED DESCRIPTION

FIG. 1 shows a guitar body 1 according to the invention, seen from the rear, comprising a soundboard 2, body sides 3 and a detached bottom deck 4. To be complete, the instrument comprises a neck not shown that may be detached from the case 1 and a headstock that may (or may not) be separated from the neck. There are many devices that ensure this assembly and disassembly of the various 15 parts of the guitar (see, for example, U.S. Pat. No. 7,705,224).

The bottom deck 4 of the guitar is assembled to the body by encompassing a drop edge 4a on the exterior of the free edge 3a of the body sides. Preferably, the bottom deck and body sides co-operate by means of an externally flush socket, i.e., in the same way as a swaging in a metal assembly, the exterior surface of the body at the junction of the body sides and bottom deck is without any discontinuity.

This socket is adjusted and the drop edge 4a of the bottom deck 4 forms a reinforcement binding of the body sides that counters the deformation (expansion) that it undergoes due to the string tension.

It should be noted that the body sides comprise a slight slope such that the body flares slightly from the soundboard 2 to bottom deck 4. This geometrical characteristic allows the bottom deck 4 to be able to cover the soundboard when stowing the guitar, as suggested in (FIG. 3].

It should be noted that disassembling the guitar allows access to the interior volume of the body, which is particularly advantageous while travelling. In fact, the body 1, without its bottom deck 4, may be housed in a container that may take the form of a backpack 5 as shown in FIGS. 4, 5 and 6 or a cover or finally a suitcase whose side wall 6 defines a profile of this container adapted to the external profile of the body and that has two walls 7 and 8 that form independent access panels opposite the interior volume of this container.

This container may, optionally, be equipped with an interior trim 9 that, when covered by the case, constitutes both protection for the walls of the body and a means of containing, within the container, the personal effects that the user has stowed in his/her travel bag. Thus, [FIG. 4] shows this trim on the convex side accessible through the opening panel 8, forming, in this case, the rear panel of the backpack. The interior of this trim is thus a compartment to house the user's personal effects. [FIG. 6] shows the other side of the trim which has embossings 9a or inserts 9b to, for example, wedge the neck 10 of the guitar or accommodate certain protrusions in the structure of the body. [FIG. 5] shows the pack in [FIG. 6] to which has been added the body 1 which fits the trim 9 and the accessories that it holds. It then suffices to cover the body by means of the bottom deck 4, as in [FIG. 3], and to close up the opening panel 8, opposite panel 7. The user may then place their personal effects into the interior of the bag or the suitcase by opening the panel 7. The trim may be independent of the container but preferably it will be secured to it by means of one of its edges.

With reference to FIGS. 1 to 3, the body 1 has a housing 11 in which the neck 10 fits in the usual way. It is then necessary to clamp it in this housing, and to do so, the invention proposes to install a sleeve 12 along the interior face of the body sides 3 in which a clamping mechanism may slide between a position that remains inactive when the bottom deck is not associated with the body and an active position when the bottom deck is mounted to the body, to prohibit the possibility of fixing the neck and strings while the body is not in a condition to resist the stresses induced by the string tension.

FIG. 7 shows the sleeve 12 in which a support 13 is mounted by a sliding motion for a flange comprising a rod 14 hinged to the support 13 and the free end of which is equipped with a clamping head 15. A spring 16 has the effect of urging the clamping head 15 against the base 11a of the housing 11. The bottom deck 4 is provided with a captive bolt 17 (with a wing nut 17a) that is directed towards the end of the support 13 such that, when the bottom deck is fitted to the body, on the edge 3a of the body sides, the captive bolt 17 pushes the support 13 to protrude the clamping head 15, by compressing the spring 16, in the housing 11.

The neck 10 comprises a cavity 18, open on the side of the base 11a of the housing 11, with a slot 18a, wider than the clamping head 15, the end 18b of which is shaped in a cam surface which slides over this clamping head 15 when the neck 10 is pushed into the housing 11. This sliding is accompanied by a tilting of the clamping rod 14 until the clamping head 15 fully penetrates the cavity 18 and returns to its original orientation under the action of a transverse return spring 20, acting on a transverse pusher 21. At this point, the clamping head 15 is engaged in cavity 18 with the rear edge 19 of the cam surface 18b. The pusher 21 is accessible by the user through the body sides such that the clamping head 15 can be released so that it can exit the cavity 18 through the slot 18a and thus remove the neck 10. This pusher may also be used when assembling the neck, thus eliminating the need for a cam surface.

The neck is completely secured to the body by screwing the bolt 17 into the support 13 tapped for this purpose, so as to create a clamping force of the neck against the bottom deck 11a of the housing 11.

Finally, it should be noted that, conventionally, the soundboard 2 is equipped with a bridge 22 with its nut 23. Advantageously, this bridge may accommodate a tailpiece 24 (FIG. 81) to which the strings 25 are attached, by means of simple nesting parallel to the plane of the soundboard 2. The fixing of the neck, as described above, is performed after the tailpiece has been fitted in the bridge, such that the instrument is ready for use.

1. A travel guitar comprising, on the one hand, a body delimited by a soundboard (2), sides or body sides (3) and a bottom deck (4) and, on the other hand, a neck (10) and a headstock and strings, which are detachable from the body, the bottom deck (4) being also detachable from the body to gain access to the interior volume thereof, characterized in that the means for assembling the bottom with the body (1) consist of a peripheral rim (4a) of the bottom deck to form a peripheral binding tightly encompassing the free edge (3a) of the body sides (3).

2. The guitar according to claim 1, characterized in that the edge (3a) of the guitar body sides (3) and the edge (4a) of the bottom deck (4) co-operate by means of an externally flush socket.

3. The guitar according to claim 1 or claim 2, characterized in that the body comprises a housing (11) for receiving the end of the neck (10) limited by a base surface (11a) on which an above-mentioned clamping device secures the neck, characterized in that the clamping device comprises a flange (15) for clamping the neck (10) onto the body (1), movably mounted between an inactive position resting on the base surface (11a) of the housing (11), achieved by the action of a return spring (16) and an active position, distant from this surface (11a) and achieved by a pusher (17) secured to the bottom deck (4), opposing the action of the spring (16), when the latter (4) is assembled to the body (1).

4. The guitar according to claim 3, characterized in that the flange is carried by a rod (14) of which one free end carries the clamping head (15) and the other end is hinged to a support (13), sliding into a sleeve (12) fitted to an inner face of the body sides (3) of the body and subjected to the above-mentioned action of the spring (16) and to the opposing action of the pusher (17).

5. The guitar according to claim 4, characterized in that the above-mentioned rod (14) co-operates laterally with a transverse pusher (21) to tilt it around its hinge on the support (13), to move the clamping head (15) in an escapement position, against the action of another return spring (20) that tends to keep it in its clamping orientation.

6. The guitar according to claim 5, characterized in that the above-mentioned pusher (17) is formed by the end of a captive bolt in the bottom deck (4) of the body and comprising on the exterior of the latter a wing nut (17a) for it to be screwed/unscrewed within the support (13) of the clamping rod for tightening/loosening the flange (15) against the neck (10).

7. The guitar according to any one of the preceding claims, characterized in that the soundboard (2) is provided and securely fixed to a bridge (22) comprising its nut (23) and to which is attached, in releasable manner, a tailpiece (24) to which the strings (25) are permanently attached.

8. The travel set consisting of the guitar according to any one of the preceding claims and a container thereof such as a bag, suitcase or cover having a front wall (8) and a rear wall (7), characterized in that each wall forms an access panel within the interior of the container.
